(19) United States
(12) Patent Application Publication
(10) Pub. No.: US 2013/0257713 A1
(43) Pub. Date: Oct. 3, 2013

(54) OPERATION DISPLAY DEVICE AND OPERATION DISPLAY METHOD

(71) Applicant: Masahiro YAMADA, Tokyo (JP)

(72) Inventor: Masahiro YAMADA, Tokyo (JP)

(21) Appl. No.: 13/691,514

(22) Filed: Nov. 30, 2012

(30) Foreign Application Priority Data
Mar. 30, 2012 (JP) 2012-081070

(51) Int. Cl. G06F 3/01

(52) U.S. Cl. CPC G06F 3/01
USPC 345/156

(57) ABSTRACT

According to one embodiment, an operation display device includes: display; proximity detectors; icon storage module; arrangement storage module; position acquisition module; and starting module. The proximity detectors each detect proximity of a terminal to the display and acquire identification information of the terminal. The icon storage module stores therein an icon displayed on the display, a computer program, and first position information of the icon on the display, in association with each other. The arrangement storage module stores therein position information of each of the proximity detectors. The position acquisition module acquires second position information of the terminal in proximity to the display. The starting module starts, if the first position information is identical or similar to the second position information, a corresponding program based on the identification information acquired by one of the proximity detectors having the position information closest to the second position information.

### CROSS-REFERENCE TO RELATED APPLICATIONS

This application is based upon and claims the benefit of priority from Japanese Patent Application No. 2012-081070, filed on Mar. 30, 2012, the entire contents of which are incorporated herein by reference.

### FIELD

Embodiments described herein relate generally to an operation display device and an operation display method.

### BACKGROUND

Conventionally, there has been known an operation display device provided with a user interface by means of a touch panel. In the operation display device, for example, when a user touches an icon or the like displayed on the user interface with his/her finger or a designated terminal, a predetermined computer program associated with the icon is started. In this case, there has been known a configuration such that, in order to determine whether the user touches the touch panel with his/her finger or whether the user touches the touch panel with the terminal, a detection sensor for detecting the terminal by wireless communications is provided to the operation display device and, when a terminal is detected by the detection sensor, the operation display device determines that the user touches the touch panel with the terminal.

However, for example, when the operation display device is large in size and a plurality of terminals are detected on the touch panel, there exist a case that it is impossible to determine, from terminal identification information acquired by the wireless communications, which terminal is to be processed with the operation display device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a hardware configuration of an operation display device according to a first embodiment;

FIG. 2 is an exemplary diagram illustrating a data structure of data stored in an icon storage module in the first embodiment;

FIG. 3 is an exemplary diagram illustrating a manner of arrangement of proximity detectors in the first embodiment;

FIG. 4 is an exemplary diagram of a data structure of a data table storing therein detectable ranges of the respective proximity detectors in the first embodiment;

FIGS. 5A to 5C are exemplary diagrams illustrating screen transitions in executing a data transfer program in the first embodiment;

FIGS. 6A to 6E are exemplary views illustrating user interface screens of when data is transferred, in the first embodiment;

FIG. 7 is an exemplary view of a user interface screen displayed when access restriction is removed in the first embodiment;

FIG. 8 is an exemplary flowchart of processing for removing the access restriction for a folder, in the first embodiment;

FIG. 9 is an exemplary flowchart of processing for starting a computer program in the first embodiment;

FIG. 10 is an exemplary flowchart of processing of a computer program to be started in the first embodiment;

FIG. 11 is an exemplary diagram of a user interface screen for electronic account settlement in the first embodiment;

FIG. 12 is an exemplary diagram of a hardware configuration of an operation display device according to a second embodiment;

FIG. 13 is an exemplary timing chart indicating triggers of time measurements in the second embodiment;

FIG. 14 is another exemplary timing chart indicating triggers of time measurements in the second embodiment; and

FIG. 15 is still another exemplary timing chart of a timing chart illustrating triggers of time measurements in the second embodiment.

### DETAILED DESCRIPTION

In general, according to one embodiment, an operation display device comprises: a display; a plurality of proximity detectors; an icon storage module; an arrangement storage module; a position acquisition module; and a starting module. The proximity detectors are each configured to detect proximity of a terminal to the display, to acquire identification information of the terminal, and having a detectable area smaller than the display. The icon storage module is configured to store therein an icon displayed on the display, a computer program for performing specific processing, and first position information indicative of a display position of the icon on the display, in association with each other. The arrangement storage module is configured to store therein arrangement position information of each of the proximity detectors. The position acquisition module is configured to acquire second position information indicative of a position of the terminal in proximity to the display. The starting module is configured to start, if the first position information and the second position information are compared with each other and the first position information is identical or similar to the second position information, a corresponding program based on the identification information acquired by one of the proximity detectors having the arrangement position information closest to the second position information.

Hereinafter, examples of operation display devices according to embodiments are explained in detail in conjunction with the drawings. Here, each embodiment is not limited to the example thereof. In the embodiments, the operation display device displays a user interface screen on a touch-sensitive display screen thereof, and predetermined processing is performed with a touch of a mobile terminal on the user interface screen. As the mobile terminal, a smart phone or the like can be used, and other dedicated devices may be used.

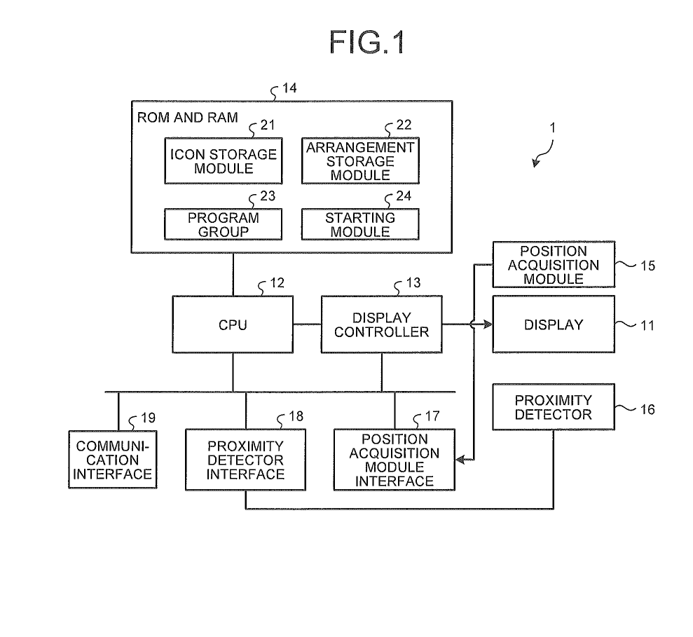

FIG. 1 is a diagram of a hardware configuration of an operation display device according to a first embodiment. As illustrated in FIG. 1, the operation display device 1 comprises a display 11, a CPU 12, a display controller 13, a ROM and RAM 14, a position acquisition module 15, a proximity detector 16, a position acquisition module interface 17, a proximity detector interface 18, and a communication interface 19.

The display 11 is constituted of a liquid crystal display panel or the like to display the user interface screen for users. The CPU 12 and the display controller 13 draw images each of which is obtained by converting information or a user interface screen into the format of image on the display 11.

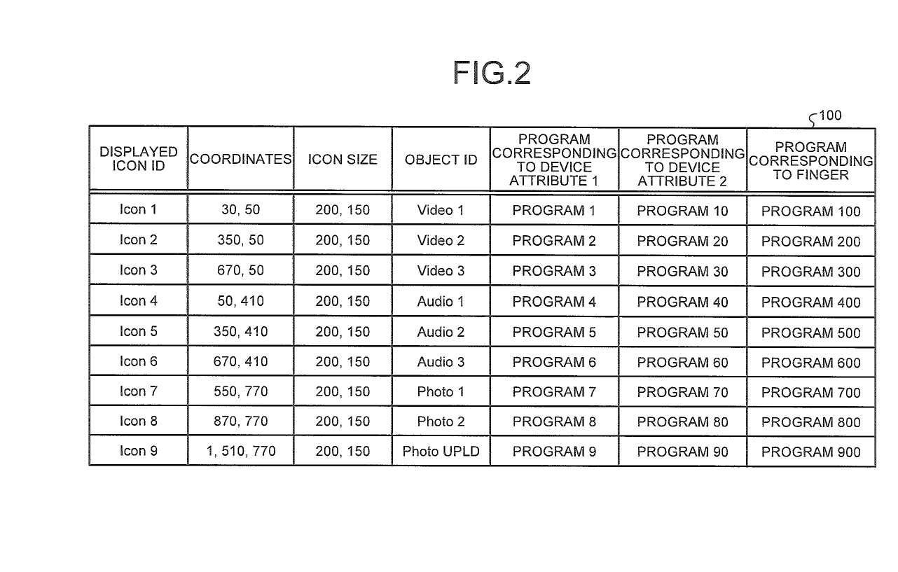

The ROM and RAM 14 comprises an icon storage module 21, an arrangement storage module 22, a program group 23, and a starting module 24. The icon storage module 21 stores therein image data of an icon displayed on the user interface screen, computer programs for performing specific processing, and first position information indicating a display position of an icon on the user interface screen displayed on the display 11, in association with each other. FIG. 2 is a diagram illustrating a data structure of data stored in the icon storage module 21. As illustrated in FIG. 2, an icon data table 50 stores therein a displayed icon ID, coordinates as one example of the first position information, an icon size, an object ID for specifying image data used for displaying an icon, a computer program started for each terminal attribute that are associated with one record. The image data of the icon specified by the object ID is drawn at a specified position on the display 11 by the CPU 12 through the display controller 13. Furthermore, in the first embodiment, there exist three types of computer programs; that is, a computer program for when the attribute of the mobile terminal is specified as type 1, a computer program for when the attribute of the mobile terminal is specified as type 2, and a computer program for when the display 11 is touched with a finger. The icon storage module 21 stores therein the correspondence relationship of the programs each of which is started with a touch on each icon.

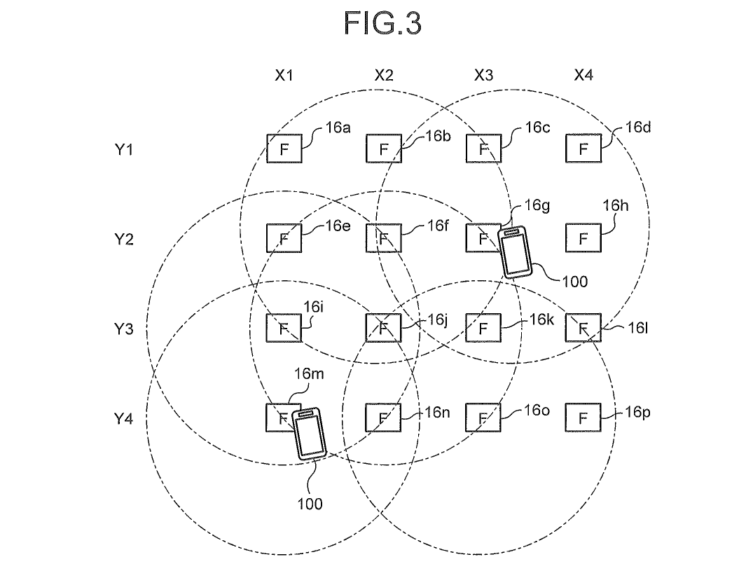

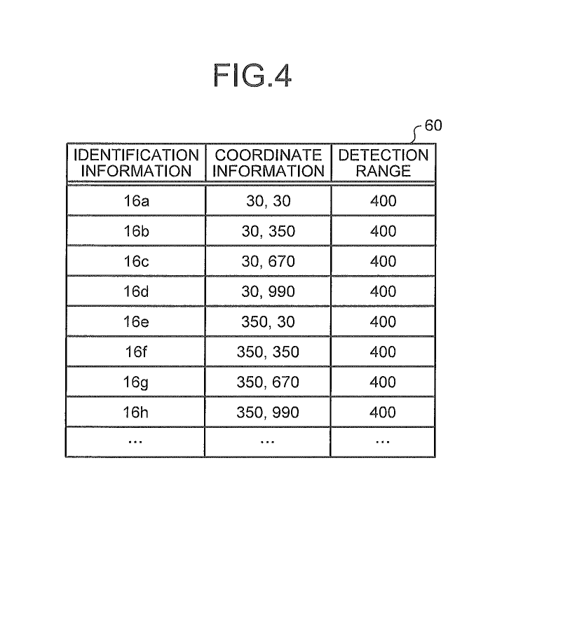

To explain the first embodiment in conjunction with FIG. 1 again, the arrangement storage module 22 stores therein detectable ranges of a plurality of such proximity detectors 16 provided. FIG. 3 is a diagram illustrating one example of a manner of arrangement of the proximity detectors 16. FIG. 4 is a diagram of a data structure of an arrangement information table 60 storing therein detectable ranges of the respective proximity detectors 16. As illustrated in FIG. 3, the proximity detectors 16 are arranged on the back side of the display 11. Each of the proximity detectors 16 is, for example, constituted of RFID or the like, and it is possible to communicate information between each of the proximity detectors 16 and a terminal on which a microchip is mounted. The arrangement position of each of the proximity detectors 16 can be specified by combining X1 to X4 in the lateral direction and Y1 to Y4 in the vertical direction. For example, the position of the proximity detector 16a can be indicated as X1Y1. The proximity detectors 16 are provided at 16 positions specified by combining X1 to X4 and Y1 to Y4, respectively. The size of the detectable range of each of the proximity detectors 16 extends to an area roughly including an adjacent proximity detector 16, and each detectable range is smaller than the display 11. The proximity detector 16 acquires, when the mobile terminal on which the detectable microchip is mounted is present within each detection range, the identification information of the mobile terminal from the mobile terminal. The proximity detector 16 temporarily stores in the ROM and RAM 14 the information that which proximity detector 16 has acquired identification information of the mobile terminal.

As illustrated in FIG. 4, the arrangement information table 60 of the arrangement storage module 22 stores therein three kinds of data of the identification information of the proximity detector 16, coordinate information, and the detection range that are associated with each other. The identification information is information for specifying each of the proximity detectors 16. The coordinate information is information of position coordinates corresponding to a position at which the proximity detector 16 is provided. Furthermore, the detection range is a value indicating the size of the detectable range of the proximity detector 16. In the first embodiment, the radius is stored as the detection range.

To explain the first embodiment in conjunction with FIG. 1 again, the program group 23 comprises: a computer program corresponding to the type 1 of the attribute mentioned above; a computer program corresponding to the type 2 of the attribute mentioned above; a computer program corresponding to the case that the display 11 is touched with a finger, and the like. Furthermore, in accordance with a terminal that is made in contact with the user interface screen, the starting module 24 determines a computer program to be started. To be more specific, upon acquisition of position coordinates acquired by the position acquisition module 15 at which the display 11 is touched, the starting module 24 acquires the identification information of the mobile terminal acquired by the proximity detector 16 located closest to the acquired and temporarily stored position coordinates, and starts a computer program corresponding to the attribute of the mobile terminal specified by the acquired identification information. For example, when the identification information corresponds to the type 1 of the attribute, a computer program corresponding to the type 1 of the attribute is started. Here, it is unnecessary that the position coordinates at which the mobile terminal touches and the position coordinates associated with the icon coincide or overlap with each other. The program may be started when these position coordinates are close to each other within a predetermined distance.

The position acquisition module 15 acquires position coordinates at which the mobile terminal touches the display 11. Here, the position coordinates is one example of second position information. The position acquisition module 15 is constituted of a touch sensor film adhered to the surface of the display 11. In the touch sensor film, sensors are arranged in the X-axis direction and the Y-axis direction. When the user touches the touch sensor film with a finger, a hand, or the like, or when the user touches the icon or the like displayed on the screen with the mobile terminal or the like, the touch film sensors detect these touches and operation instruction signals are transmitted to the CPU 12. Here, it is unnecessary to actually touch the touch sensor film. In a state that the finger or the mobile terminal is nearly brought into contact with the touch sensor film, the finger or the mobile terminal may be detected assuming that the finger or the mobile terminal touches the touch sensor film. The position coordinates acquired by the position acquisition module 15 is input to the CPU 12 through the position acquisition module interface 17. The identification information of the mobile terminal detected by the proximity detector 16 is input to the CPU 12 through the proximity detector IF module 18. Furthermore, the operation display device 1 can perform data transmissions and receptions to a mobile terminal 100 by the Bluetooth (registered trademark) or the wireless LAN, Internet communications by the wireless LAN, or the like.

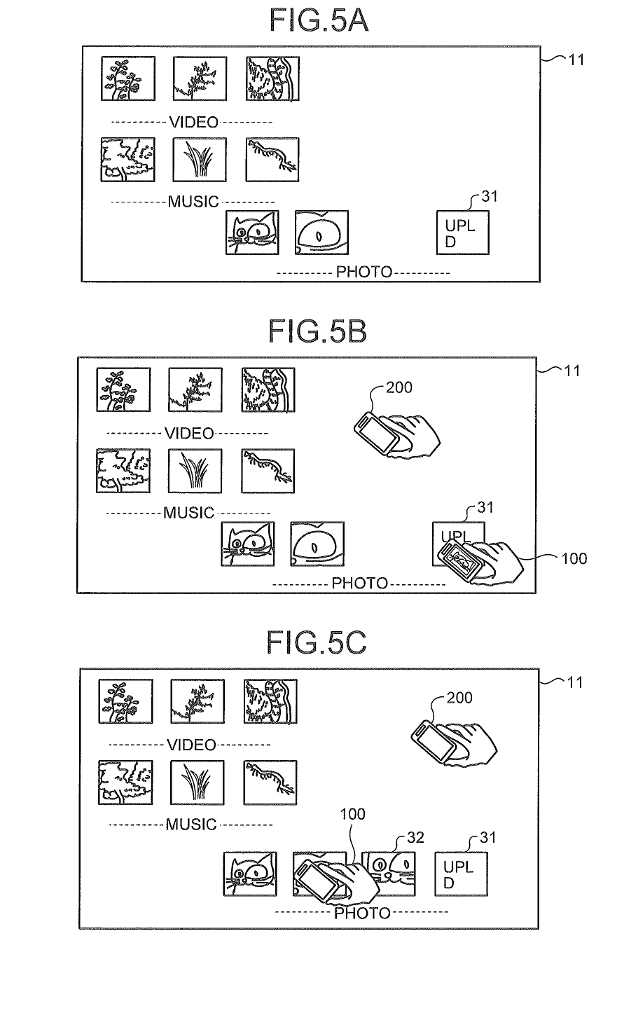

FIGS. 5A to 5C illustrate examples of the user interface screens in executing a data transfer program in the operation display device 1 in the first embodiment. As illustrated in FIG. 5A, the display 11 of the operation display device 1 displays thereon three kinds of data of videos, three kinds of data of music, and two kinds of data of photographs that are stored in the ROM and RAM 14 with the use of icons different to one another. Furthermore, an upload icon 31 for uploading data selected on the side of the mobile terminal is displayed.

A case that the user interface screen of the display 11 is touched by two different mobile terminals 100 and 200 is explained. FIG. 5B illustrates a state that the mobile terminal 100 is placed on the upload icon 31 and the mobile terminal 200 is placed at a position such that the mobile terminal 200 does not touch any icon. In this case, the proximity detector 16 detects both of the mobile terminals 100 and 200, and two pieces of the identification information of the respective mobile terminals 100 and 200 are acquired. Meanwhile, a computer program for uploading data is executed with respect to the mobile terminal 100 specified by the identification information acquired by the proximity detector 16 located closest to the upload icon 31. Therefore, the starting module 24 starts a computer program for transferring data between the mobile terminal 100 and the operation display device 1. The operation display device 1 transfers data via the communication interface 19. Here, when the proximity detector 16 is a module for near-field wireless communications such as TransferJet (registered trademark), the operation display device 1 may transfer data using the proximity detector 16.

On the screen illustrated in FIG. 5C, an icon 32 indicating data transferred from the mobile terminal 100 to the operation display device 1 is additionally displayed next to the upload icon 31. The program identifies the type of data to determine whether the type of data is video data, music data, or photograph data, and provides an appropriate icon. Furthermore, depending on the type of data, a dedicated folder for videos, music, or the like may be designated as a storage destination.

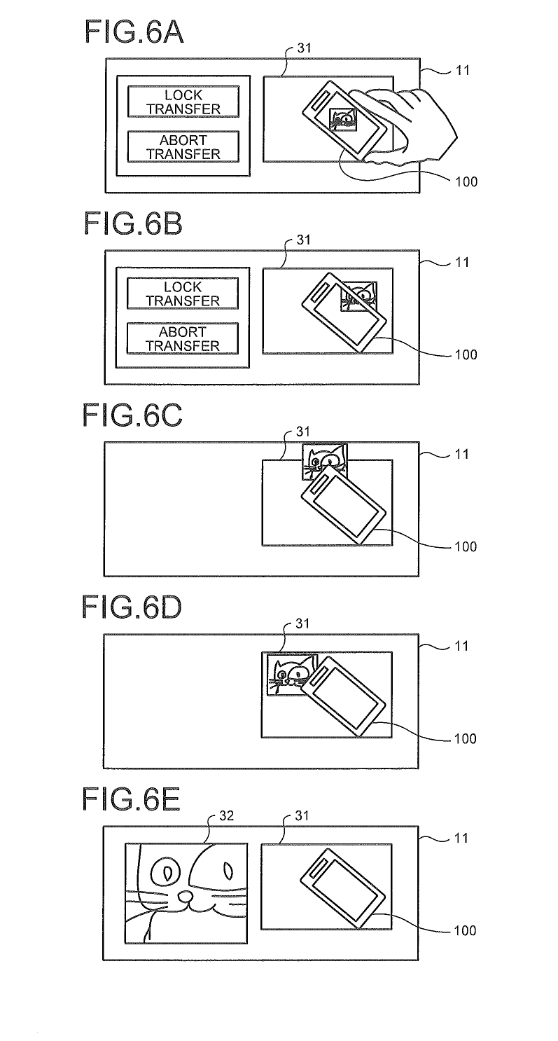

Here, one example of the user interface screen in transferring data is illustrated in FIGS. 6A to 6E. FIGS. 6A to 6E illustrate examples of graphics displayed when the mobile terminal 100 touches the display 11. As illustrated in FIG. 6A, photograph data stored in the mobile terminal 100 is displayed in the form of icons or the like on the screen of the mobile terminal 100. When the mobile terminal 100 touches the display 11 of the operation display device 1, data transfer is started.

Next, as illustrated in FIGS. 6B to 6D, a part of the icon corresponding to a degree of progressing the data transfer; to be more specific, a ratio of an amount of transferred data or an amount of non-transferred data to a total amount of data and the other part of the icon are displayed on the screen of the mobile terminal 100 and on the display 11, respectively. The position of the icon displayed on the display 11 of the operation display device 1 is determined based on the position coordinates of the mobile terminal 100 acquired by the position acquisition module 15. The display 11 displays the icon to be displayed on the display screen of the mobile terminal 100 and the icon to be displayed on the display 11 so that these icons are superimposed to be viewed as one icon. As illustrated in FIG. 6E, the display 11 displays the icon 32 at a position next to the upload icon 31 when the data transfer is completed. The program identifies the type of data and displays the icon at a position corresponding to the type of data, i.e., whether the data is video data, music data, or photograph data, and the processing for transferring data is completed.

In this manner, by displaying the process of the data transfer on the display 11, it is possible to display the icon being viewed as if the data is transmitted from the mobile terminal 100 to the operation display device 1 and the icon of the data is entered into the display 11.

Here, when the mobile terminal 100 touches the display 11, the data transfer may not be started immediately and a dialogue for confirming may be displayed on the mobile terminal 100 to confirm the operation with the user. Due to such a configuration, it is possible to prevent the data transfer from being performed against the user's intention when a false determination is made whether the mobile terminal 100 touches the display 11.

Furthermore, based on FIG. 5C, an operation when the mobile terminal 100 touches the icon indicating data such as a moving picture or a photograph is explained. For example, when the mobile terminal 100 touches the second photograph icon from the left, the position acquisition module 15 acquires position coordinates at a position where the mobile terminal touches. In this case, out of the identification information of the mobile terminals 100 and 200 that the proximity detector 16 acquires, the identification information of the mobile terminal detected by the proximity detector 16 present closest to the position coordinates where the mobile terminal touches is specified, and the photograph data is transferred to the specified mobile terminal 100.

When data is transferred from the operation display device 1 to the mobile terminal 100, a part of the area of the icon corresponding to the ratio of an amount of data completed to be transferred or an amount of data transferred to the total amount of data is displayed on the screen of the mobile terminal 100. Meanwhile, on the display 11 of the operation display device 1, based on the position coordinates acquired by the position acquisition module 15, the other part of the area of the icon corresponding to the ratio of an amount of data not transferred to the total amount of data (an area not displayed on the mobile terminal) is displayed.

Furthermore, the operation display device 1 may receive the information of the pixel density of the screen of the mobile terminal 100 or the information of a resolution and a screen size of the mobile terminal 100 to display thereon the icon whose size is adjusted thereby. Conversely, the operation display device 1 may transmit the information of the pixel density thereof or the information of the resolution and the screen size thereof to the mobile terminal to display, on the mobile terminal 100, the icon whose size is adjusted by the mobile terminal 100. Due to such configuration, the mobile terminal 100 and the operation display device 1 can display icons having sizes identical with each other or substantially identical with each other. The operation display device 1 may acquire information with respect to the direction of the mobile terminal 100 to display an icon corresponding to the direction indicated by the information. Here, these kinds of processing may be performed in the process explained in conjunction with FIG. 5B. That is, when the mobile terminal 100 is placed on the upload icon 31 and the data transfer is started, the mobile terminal 100 and the operation display device 1 may display icons having sizes identical with each other or substantially identical with each other.

When the identification information is not detected by the proximity detector 16, the starting module 24 determines that the icon is touched with a hand, and photograph data indicated by the icon is displayed on the display 11.

When the mobile terminal 100 is moved away from the display 11 in the course of data transfer, the display 11 and the mobile terminal 100 stop the data transfer. A user can intuitively instruct the stop of the data transfer without performing special operations for canceling. The display 11 may, for example, display dialogs of “LOCK TRANSFER” and “ABORT TRANSFER” as illustrated in FIGS. 6A and 6B before starting the data transfer or during the data transfer. When the dialog is not selected, data transfer is stopped by moving the mobile terminal 100 away from the display 11 after starting the data transfer. However, when “LOCK TRANSFER” is selected, the data transfer continues even when the mobile terminal 100 is moved away from the display 11. In this manner, it becomes unnecessary for a user to touch the display 11 with the mobile terminal 100 continuously during the data transfer.

Furthermore, when “ABORT TRANSFER” is selected, the data transfer is aborted. When “LOCK TRANSFER” is selected, the data transfer is not stopped even when the mobile terminal 100 is moved away from the display 11. Here, when a user expects to interrupt the data transfer during the data transfer, the selection of “ABORT TRANSFER” results in abortion of the data transfer.

Here, as illustrated in FIGS. 5A to 5C, when the display 11 displays a plurality of icons on the screen thereof, the display 11 may arrange each of the icons at each position corresponding to the proximity detectors 16. When data transmission is performed by using a module for the near-field wireless communication such as the TransferJet, a communication quality is enhanced when a transmission-side coupler and a receiving-side coupler face to each other in an opposed manner. Accordingly, when the proximity detector 16 is the module for the near-field wireless communication, the display 11 displays, for example, an icon at a position such that the icon covers the proximity detector 16 thus performing the data transfer with high communication quality. Here, in this case, the operation display device 1 controls the display position of the icon based on the arrangement information table 60 illustrated in FIG. 4.

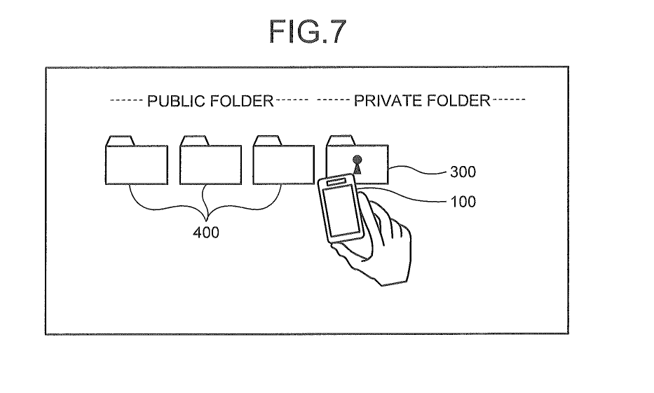

FIG. 7 illustrates one example of a user interface screen displayed when canceling access restrictions in accessing data stored in the ROM and RAM 14 of the operation display device 1. The data stored in the ROM and RAM 14 is stored in the form of a folder structure. Data capable of being accessed by any users is stored in a public folder, and data capable of being accessed only by authorized users is stored in a private folder.

In the first embodiment, the mobile terminal 100 is capable of canceling the access restrictions to a private folder 300. Public folders 400 are indicated each using an icon without a key, and the private folder 300 is indicated using an icon with a key. When the icon with the key is touched with a specific mobile terminal, the position acquisition module 15 first acquires position coordinates of the display position of the private folder 300 touched by the mobile terminal 100 on the display 11 of the operation display device 1. Furthermore, the proximity detector 16 detects the mobile terminal 100 close to the icon to acquire the key information of the mobile terminal 100. The starting module 24 cancels the access control of the private folder 300 based on the key information acquired.

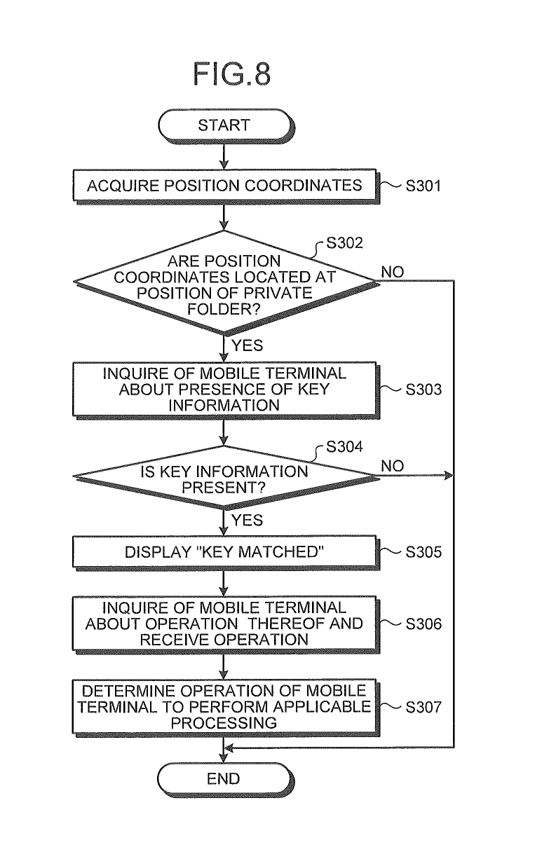

Hereinafter, the flow of processing for canceling a key by the mobile terminal is explained based on FIG. 8. As illustrated in FIG. 8, first of all, the position acquisition module 15 acquires position coordinates of a position at which a mobile terminal touches the display 11 (S301). Next, the starting module 24 determines whether the position coordinates acquired are located at the position of the private folder 300 (S302). When it is determined that the position coordinates are located at the position of the private folder 300 (Yes at S302), the starting module 24 inquire of the mobile terminal about whether the mobile terminal has key information for the private folder 300 (S303). There may be two kinds of key information; that is, key information indicating that only reading of data is permitted, and key information indicating that both reading of data and writing of data are permitted. On the other hand, when the starting module 24 determines that the position coordinates acquired are not located at the position of the private folder 300 (No at S302), the processing is ended, and another applicable computer program is started or nothing is performed.

Next, the starting module 24 determines whether the mobile terminal has key information (S304). When it is determined that the mobile terminal has the key information (Yes at S304), a message of “KEY MATCHED” is displayed (S305). In this case, another message may be displayed. Furthermore, the message may also be displayed on the display 11 or on the display of the mobile terminal. On the other hand, when it is determined that the mobile terminal has no key information (No at S304), the starting module 24 finishes the processing. Next, the starting module 24 inquires of the mobile terminal about the operation thereof, and receives the operation (S306). The operation of the mobile terminal is indicated by the output of an acceleration sensor provided in the mobile terminal. The starting module 24 determines the operation of the mobile terminal to start a computer program assigned for each operation, and finishes the processing (S307).

For example, the case that the key information indicates that both reading and writing are permitted is explained. When the mobile terminal is rotated approximately 90 degrees at the position of the private folder 300, the access restriction of reading to the private folder 300 is removed. Furthermore, when the mobile terminal is rotated approximately 180 degrees at the position of the private folder 300, the access restrictions of reading and writing to the private folder 300 are removed. In this case, completion of cancellation may be displayed on the display 11 and the display screen of the mobile terminal. Furthermore, the access restriction of any of reading and writing may be determined to be removed based on the direction of rotating the mobile terminal. Furthermore, when the key information indicates that only reading is permitted, and when the mobile terminal is rotated approximately 180 degrees, a message of “THIS MOBILE TERMINAL IS PERMITTED ONLY TO READ DATA” may be displayed to urge a reading cancellation operation such that the mobile terminal is rotated approximately 90 degrees to a user. Here, as a method for detecting the rotation of the mobile terminal 100 by the operation display device 1, a method for detecting a contact position of the mobile terminal 100 on the display 11, a method for acquiring information with respect to the direction of the mobile terminal 100 from the mobile terminal 100, or the like is named. Here, when the identification information of the mobile terminal 100 is acquired with the key information to remove once the access restriction, the access restriction may also be, the second time the mobile terminal is touched the display 11 or later, removed based on the identification information of the mobile terminal 100 without acquiring the key information.

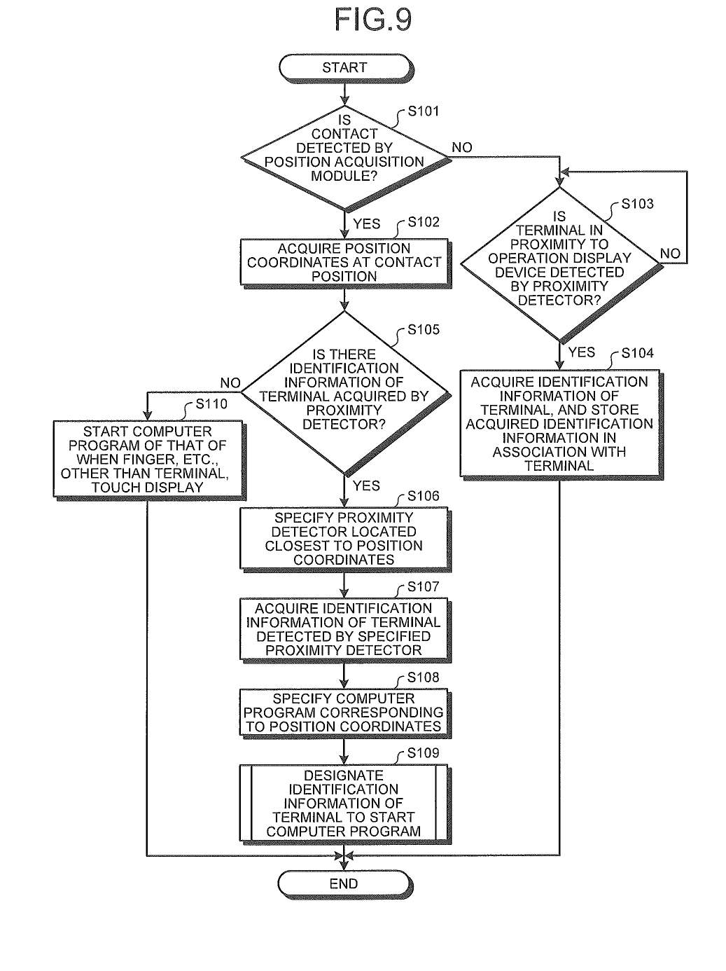

Next, the flow of processing for starting a computer program in the operation display device 1 is explained in conjunction with FIG. 9. As illustrated in FIG. 9, the position acquisition module 15 determines whether contact with the display 11 is made (S101). When it is determined that the contact with the display 11 is made (Yes at S101), the position acquisition module 15 acquires position coordinates at a position where the contact is made (S102). On the other hand, when it is determined that the contact is not made, the processing is repeated.

Furthermore, in parallel with the detection of the contact with the display 11 by the position acquisition module 15 at S101 and S102, processing for detecting the proximity of the mobile terminal to the operation display device 1 is performed. The proximity detector 16 determines whether to detect the mobile terminal adjacent to the operation display device 1 or not (S103). Here, each of the proximity detectors 16 in plurality performs determination processing at S103. When it is determined that the mobile terminal adjacent to the operation display device 1 is detected (Yes at S103), the proximity detector 16 acquires and stores therein the identification information of the mobile terminal associated with the identification information thereof (S104). Here, the proximity detector 16 temporarily stores therein the identification information acquired. For example, the proximity detector 16 stores therein the identification information only while each of the proximity detectors 16 can detect the mobile terminal. This configuration can be realized by a method such that when the mobile terminal is left from the detectable range, the identification information stored in the proximity detector 16 is deleted.

Next, the starting module 24 determines whether the identification information of the mobile terminal acquired by the proximity detector 16 is stored and present in the proximity detector 16 (S105). When it is determined that the identification information of the mobile terminal is stored (Yes at S105), the starting module 24 specifies the proximity detector 16 closest to the position coordinates that the contact is made (S106). The position of the proximity detector 16 is acquired in reference to the position information stored in the arrangement storage module 22. Next, the starting module 24 acquires the identification information of the mobile terminal detected by the proximity detector 16 specified (S107). Next, the starting module 24 selects a computer program to be started from the program group 23 referring to the icon storage module 21 based on the position coordinates of the icon touched (S108). The starting module 24 designates the identification information of the mobile terminal specified to start the program selected (S109). On the other hand, when it is determined that the identification information of the mobile terminal is not stored (No at S105), the starting module 24 starts a computer program corresponding to the case of the contact of a finger or the like other than the mobile terminal (S110).

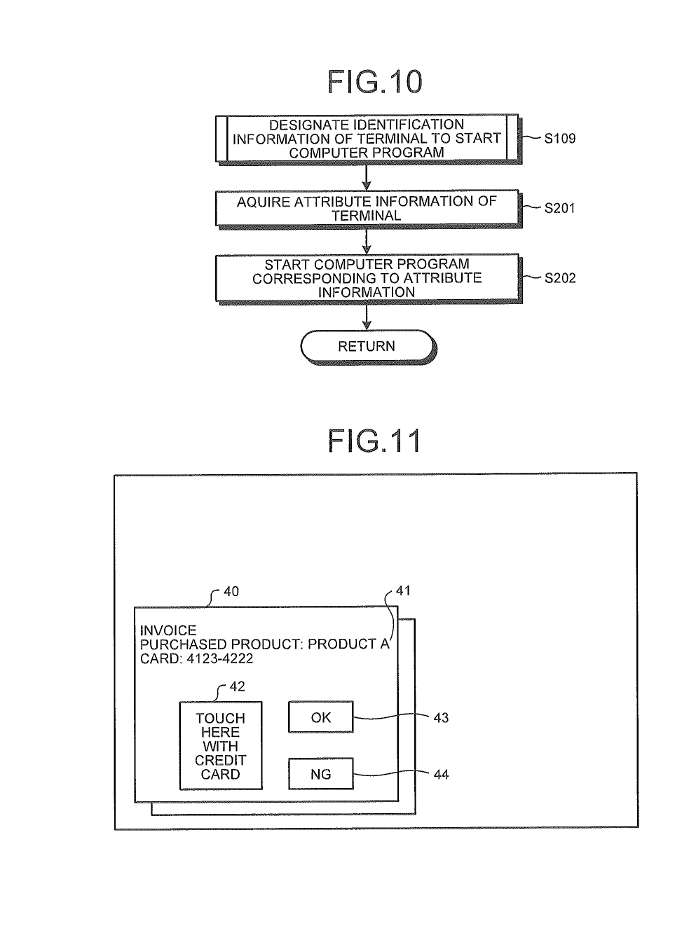

Next, the detailed processing flow of the computer program to be started is explained in conjunction with FIG. 10. As illustrated in FIG. 10, first of all, the starting module 24 acquires the attribute of the mobile terminal from the identification information of the mobile terminal designated (S201). Examples of the attributes to be acquired are applicable data formats, display screen sizes, executable functions, communication methods, and the like. The attribute of the mobile terminal acquired is stored. Here, the starting module 24 may, for example, acquire these attributes from the communication interface 19 through the Internet or store these attributes in the operation display device 1 in advance as a database.

The starting module 24 starts a computer program corresponding to the attribute of the mobile terminal acquired (S202). As the specific example of the program, when the program transfers a music file to the mobile terminal, processing for converting the music file into a file format corresponding to the mobile terminal is performed based on the attribute information such that the mobile terminal is capable of reproducing MP3-format files or AAC-format files. When the contact of the mobile terminal is made, the music file is transferred after such conversion processing is properly performed. Furthermore, when the program transfers a moving-picture file to the mobile terminal, the moving-picture file is transferred after the resolution of the moving picture is converted into a resolution corresponding to the screen size of the mobile terminal to be a transfer destination based on the attribute information such that the screen size of the mobile terminal is 1920×1080 pixels or 640×480 pixels.

Furthermore, a communication module in transferring data can also be changed based on the attribute information such that the mobile terminal to be a transfer destination is capable of communicating by the wireless LAN or the Bluetooth (registered trademark). In addition, in transferring data, size information indicating the whole size of the mobile terminal is acquired from a predetermined size storage module, an image of the shape of a terminal corresponding to the mobile terminal is drawn on the display 11 based on the size information of the mobile terminal acquired, and the drawn image of the mobile terminal and a route for performing data transfer between the other user interface and the mobile terminal are displayed and hence, it becomes possible for a user to perceive visually that data is transferring. The size storage module may be provided on the Internet as a database or may also be provided in the mobile terminal or the operation display device 1. Here, when data to be transferred is a music file, a video file, a photograph file, or the like, and when it is determined that not a mobile terminal but a finger touches the display 11, data is not transferred and data reproduction processing is performed in the display 11.

On the contrary, the case that data is transferred from the mobile terminal to the operation display device 1 is explained. In this case, first of all, the program of the operation display device 1 makes an inquiry of the mobile terminal side about a kind of data to be transferred. On this occasion, the mobile terminal displays data selected on the display screen thereof and transfers the attribute information of the data selected to the operation display device 1 side. However, when data is not selected and the attribute information thereof is not transferred, the operation display device 1 displays a message of “SELECT DATA TO BE TRANSFERRED”.

Next, the operation display device 1 determines whether which data out of the music data, video data, and photograph data is acquired from the attribute information of the data acquired, and a predetermined dedicated folder is set as a transfer destination for each data. At the same time, a display position on the display 11 and the kind of the icon are set. Furthermore, a folder for each time and date may be set as a transfer destination based on the time-and-date information included in the attribute information of the data. After setting processing for the data transfer is completed, the data transfer is started.

In addition, as the other program to be started, for example, a computer program for electronic account settlement can also be adopted. FIG. 11 illustrates a user interface screen 40 for electronic account settlement displayed when a product is purchased. The user interface screen 40 for electronic account settlement comprises a purchasing information display area 41 for displaying information of the product purchased and information of a card used for payments, a touch area 42, an OK button 43, and an NG button 44. The touch area 42 is a part to be touched with a card used for payments or a mobile terminal having a settlement function thereon by a user.

The starting module 24 determines from the position coordinates acquired by the position acquisition module 15 whether the contact is made at a position of any of the touch area 42, the OK button 43, and the NG button 44. In the case where it is determined that the contact is made at the position of the touch area 42, when the proximity is detected by the proximity detector 16, settlement information is acquired from the card or the mobile terminal specified by the identification information thereof. On the other hand, when the proximity is not detected by the proximity detector 16, a message of “TOUCH WITH A CARD FOR PAYMENTS” or the like is displayed.

Furthermore, when it is determined that the contact is made at the position of the OK button 43, the settlement of accounts is performed based on the settlement information acquired. When it is determined that the contact is made at the position of the NG button 44, the settlement information acquired is deleted. Here, it is desirable to set the display position of the user interface screen 40 for the electronic account settlement to a position corresponding to any of the proximity detectors 16. In making a settlement, a product coupon or the like may be transferred to the mobile terminal. This processing can be performed in accordance with a flow same as the flow of the processing for transferring the above-mentioned music data or video data.

In the operation display device 1 of the first embodiment explained heretofore, when a mobile terminal is brought into contact with an icon displayed on the display 11, the program associated with the icon is started based on the identification information of the mobile terminal detected by the proximity detector 16 located closest to the icon with which the mobile terminal is brought into contact. Consequently, even when it is determined that a plurality of mobile terminals are close to the operation display device 1, a computer program corresponding to the attribute of the mobile terminal intended by a user can be started. Accordingly, it is possible to prevent the occurrence of the problem that data is transferred between the unintended mobile terminal and the operation display device 1 thus improving user's convenience.

Furthermore, the attribute information of the mobile terminal appropriate for a computer program to be started is passed to the starting module 24. Therefore, the program corresponding to the attribute of the mobile terminal can be executed thus improving user's convenience.

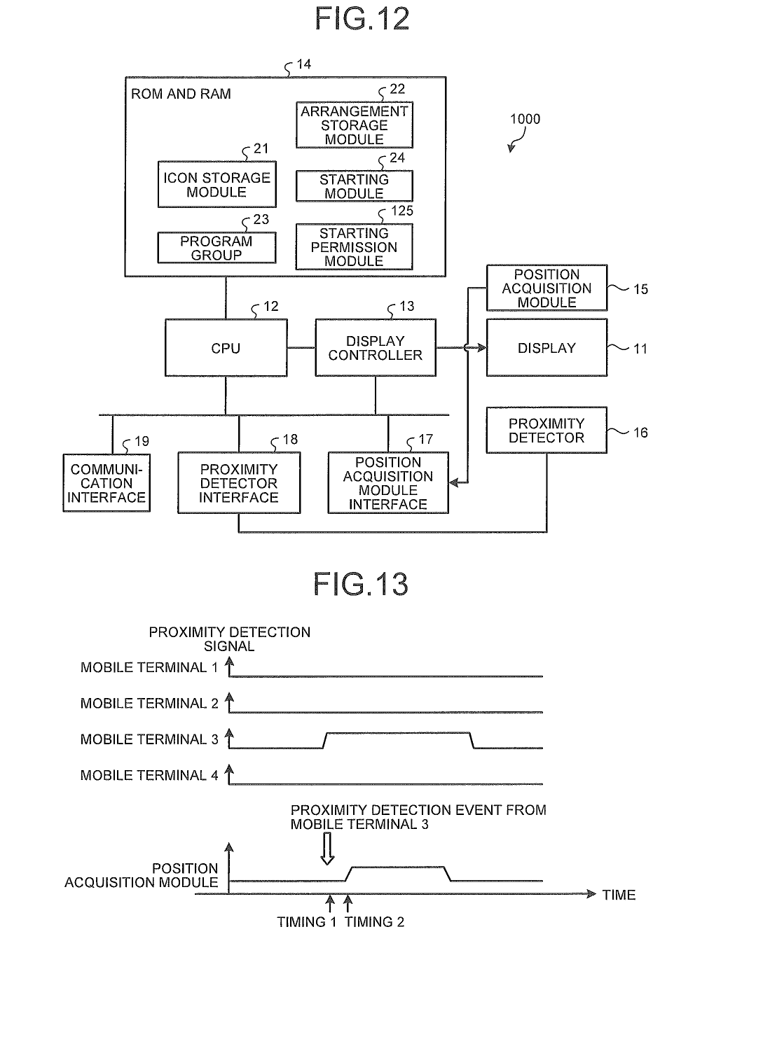

Next, a second embodiment of an operation display device is explained. In the second embodiment, as illustrated in FIG. 12, an operation display device 1000 additionally comprises a starting permission module 125. The starting permission module 125 differs from the starting module 24 in that the starting permission module 125 permits start of a computer program only when a time difference in detecting a mobile terminal between a proximity detector 16 and a position acquisition module 15 is within a predetermined threshold.

FIG. 13 is a timing chart illustrating Timing 1 at which the proximity of a mobile terminal 3 is detected by the proximity detector 16 and Timing 2 at which the contact of the mobile terminal 3 is detected by the position acquisition module 15. In the second embodiment, when a time difference between Timing 1 and Timing 2 is within a predetermined threshold, the starting permission module 125 permits start of an applicable program. To be more specific, the starting permission module 125 starts to measure a period of time at timing when the contact is detected by the position acquisition module 15. Furthermore, the starting permission module 125 starts to measure a period of time at timing when the proximity is detected by the proximity detector 16. The starting permission module 125 stops measuring of the period of time when the detection is performed by both the position acquisition module 15 and the proximity detector 16 to determine whether the difference of the measured periods of time is within a predetermined threshold.

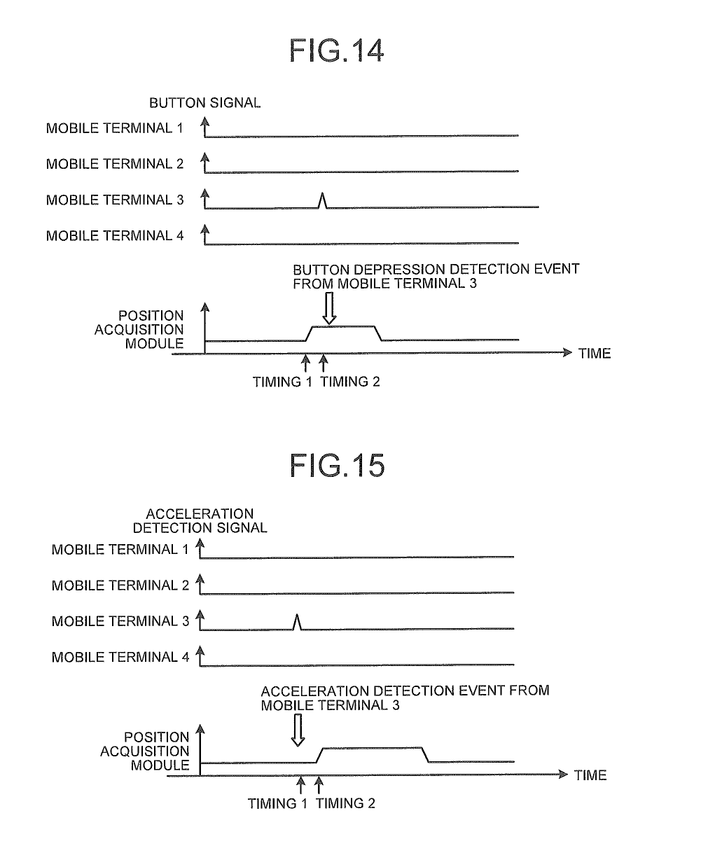

In place of the constitution that the starting permission module 125 starts to measure a period of time in response to a proximity detection signal as a trigger, it is possible to adopt the constitution that the starting permission module 125 starts to measure a period of time in response to another signal as a trigger. For example, it is possible to adopt the constitution that the starting permission module 125 starts, as illustrated in FIG. 14, to measure a period of time in response to the reception of a signal of depressing a button by the mobile terminal as a trigger, or the constitution that the starting permission module 125 starts, as illustrated in FIG. 15, to measure a period of time in response to the reception of an acceleration detection signal as a trigger from the mobile terminal provided with an acceleration sensor. In this case, these signals can be received through the communication interface 19.

According to the configuration of the second embodiment described heretofore, in the case of an irregular situation such that a time difference between acquisition of a position and detection of the mobile terminal becomes large, a computer program is not started thus preventing user-unintended processing from being performed. Here, when the time difference is larger than the predetermined threshold, the operation display device 1000 may process the contact detected by the position acquisition module 15 as an ordinary contact operation. That is, in the case where the position acquisition module 15 detects, when the operation display device 1000 displays icons indicating a moving picture, music, a photograph, and the like, the contact with respect to the positions of these icons and the time difference between acquisition of the position and detection of the mobile terminal is larger than the predetermined threshold, the operation display device 1000 reproduces, for example, data corresponding to the icon.

Here, the programs described in the first and second embodiments are examples of programs executable in the operation display device 1, and the embodiments can also be applied to the case that other programs are executed.

In addition, the area of the detectable range of each of the proximity detectors 16 may be set larger than the display 11. In this case, the operation display device may also comprise the one proximity detector 16, not the proximity detectors 16.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An operation display device comprising:
a display;
a plurality of proximity detectors each configured to detect proximity of a terminal to the display, to acquire identification information of the terminal, and having a detectable area smaller than the display;
an icon storage module configured to store therein an icon displayed on the display, a computer program for performing specific processing, and first position information indicative of a display position of the icon on the display, in association with each other;
an arrangement storage module configured to store therein arrangement position information of each of the proximity detectors;
a position acquisition module configured to acquire second position information indicative of a position of the terminal in proximity to the display; and
a starting module configured to start, if the first position information and the second position information are compared with each other and the first position information is identical or similar to the second position information, a corresponding program based on the identification information acquired by one of the proximity detectors having the arrangement position information closest to the second position information.

2. An operation display device of claim 1, wherein the program executes different processing depending on types of the terminal.

3. The operation display device of claim 1, further comprising:
a communication module configured to communicate with the terminal by non-contact communication; and
a starting permission module configured to permit, if an operation signal indicating that the terminal is operated is received through the communication module and a time difference between when the operation signal is received and when the terminal is detected by the proximity detector is less than or equal to a predetermined threshold, the starting module to start of the program.

4. The operation display device of claim 1, further comprising:
a communication module configured to communicate with the terminal by non-contact communication; and
a starting permission module configured to permit, if an acceleration detection signal of the terminal provided with an acceleration detection module is received through the communication module and a time difference between when the acceleration detection signal is received and when the terminal is detected by the proximity detector is less than or equal to a predetermined threshold, the starting module to start of the program.

5. The operation display device of claim 2, further comprising:
a retrieval module configured to retrieve size information of the terminal from a predetermined size storage module based on the acquired identification information; and
a display controller configured to display, if the size information is acquired as a result of retrieval, the shape of the terminal on the display device based on the acquired size information.

6. An operation display method comprising:
detecting proximity of a terminal to a display by a plurality of proximity detectors having detectable areas each of which is smaller than the display, and acquiring identification information of the terminal;
acquiring second position information indicative of a position of the terminal in proximity to the display; and
starting, if the second position information and a first position information stored in a storage module configured to store therein icon displayed on the display, a computer program for performing specific processing, and first position information indicative of a display position of the icon on the display, in association with each other, are compared with each other and the first position information is identical or similar to the second position information, a corresponding program based on the identification information acquired by one of the proximity detectors having the arrangement position information closest to the second position information.
